(19) United States
(12) Patent Application Publication
(10) Pub. No.: US 2023/0154474 A1
(43) Pub. Date: May 18, 2023

(54) SYSTEM AND METHOD FOR PROVIDING HIGH QUALITY AUDIO COMMUNICATION OVER LOW BIT RATE CONNECTION

(71) Applicant: Agora Lab, Inc., Santa Clara, CA (US)

(72) Inventors: Jianyuan Feng, Shanghai (CN); Yun Zhao, Shanghai (CN); Xiaohan Zhao, Shanghai (CN); Linsheng Zhao, Shanghai (CN); Fang Yuan, Shanghai (CN)

(21) Appl. No.: 17/528,217

(22) Filed: Nov. 17, 2021

(51) Int. Cl. G10L 19/16; G10L 19/02; G10L 19/008

(52) U.S. Cl. CPC G10L 19/167; G10L 19/0208; G10L 19/008

(57) ABSTRACT

A system and method for provide high quality audio in real-time communication over low bit rate network connections. The system includes real-time communication software application having an improved encoder and an improved decoder. The encoder decomposes audio data based on two frequency ranges corresponding to a super wideband mode and a wideband mode into a lower sub-band and a higher sub-band. Audio features are extracted from the lower sub-band and higher sub-band audio data. The audio features are quantized and packaged. The decoder reconstructs the audio data for playback on the receiving device based on the compressed audio features in the super wideband mode and the wideband mode.

### CROSS REFERENCE TO RELATED APPLICATIONS

None.

### FIELD OF THE DISCLOSURE

The present invention generally relates to real-time communication with audio data capture and remote playback, and more particularly relates to a real-time communication system that provides high quality audio playback when the network connect has a low bit rate. More particularly still, the present disclosure relates to a real-time communication software application with a codec that has a low bit rate audio encoder and a high quality decoder.

### DESCRIPTION OF BACKGROUND

In real-time communication (RTC), the network bandwidth (also referred as bitrate or bit rate) is oftentimes limited. When the bitrate is low, the audio signals of the RTC, encoded on the sending side by a sending electronic device (such as a smartphone, a tablet computer, a laptop computer or a desktop computer) and decoded on the receiving side by a receiving electronic device, need to be packaged into packets with reduced data size for transmission over the Internet than when the bitrate is high. Audio codecs thus are designed to compress the audio packets as small as possible while trying to preserve the audio quality after decoding.

Deep learning based audio codecs usually associates with high computational costs on the computer that performs the deep learning. The high computational cost makes the codecs unfeasible on portable devices, such as smart phones and laptops. This is particularly true in cases where multiple audio signals need to be decoded simultaneously on the same computer, such as in multi-user online meetings. When the audio packets cannot be decoded in time, discontinuous playback on the receiving device will occur and dramatically lower and decrease the listening experience.

Accordingly, for RTC, there is a need for a new low bit rate audio codec with a high-quality decoder that can achieve the purpose of saving the costs on network bandwidth and preserving the quality of RTC experience in a weak network situation. The network bandwidth can vary at different times. For example, when the network signal is weak or too many devices sharing the same network, the available network bandwidth can drop to a very low level or range. In such cases, the audio packet loss rate will be increased, which will result in discontinuous audio signals. The reason is that some of the packets of audio data (also referred to herein as audio signals) are dropped or blocked due to the poor network bandwidth. Therefore, only the audio codec with a low bit rate can provide the continuous audio stream for playback on the receiving side when the network bandwidth is limited.

### SUMMARY OF THE DISCLOSURE

Generally speaking, pursuant to the various embodiments, the present disclosure provides a computer-implemented method for providing high quality audio for playback over a low bit rate network connection in real-time communication. The method is performed by a real-time communication software application and includes receiving a stream of audio input data on a sending device; suppressing noise from the stream of audio input data to generate clean audio input data on the sending device; splitting the clean audio input data into a set of frames of audio data on the sending device; standardizing each frame within the set of frames to generate a set of frames of standardized audio data on the sending device, wherein audio data of the frame is resampled according to two frequency ranges corresponding to a wideband mode and a super wideband mode, thereby forming lower sub-band audio data and higher sub-band audio data; extracting a set of audio features for each frame within the set of frames of standardized audio data, thereby forming a set of sets of audio features on the sending device; quantizing the set of audio features for each frame within the set of frames of standardized audio data into a compressed set of audio features on the sending device; packaging a set of the compressed sets of audio features into an audio data packet on the sending device; sending the audio data packet to a receiving device on the sending device; receiving the audio data packet in the super wideband mode on a receiving device; retrieving the set of audio features for each frame within the set of frames of standardized audio data from the audio data packet on the receiving device; within both a lower sub-band and a higher sub-band of the super wideband mode, determining a linear prediction value of the following sample for each sample of the audio data of each frame based on the set of audio features corresponding to the frame on the receiving device; extracting a context vector for residual signal prediction from acoustic feature vectors for the sample in the lower sub-band on the receiving device using deep learning method; determining a first residual prediction for the sample in the lower sub-band on the receiving device; combining the linear prediction value and the first residual prediction to generate a sub-band audio signal for the sample in the lower sub-band on the receiving device; de-emphasizing the sub-band audio signal to form a de-emphasized lower sub-band audio signal on the receiving device; determining a second residual prediction for the sample in the higher sub-band on the receiving device; combining the linear prediction value and the second residual prediction to generate a sub-band audio signal for the sample in the higher sub-band on the receiving device; merging the de-emphasized lower sub-band audio signal and the sub-band audio signal for the sample in the higher sub-band, thereby forming a merged audio sample on the receiving device; and transforming the merged audio sample to audio data for playback on the receiving device. Extracting a set of audio features for each frame within the set of frames of standardized audio data in the super wideband mode includes applying a pre-emphasis process on the lower sub-band audio data with a high pass filter, thereby forming pre-emphasized lower sub-band audio data; performing Bark-Frequency Cepstrum Coefficients (BFCC) processing on the pre-emphasized lower sub-band audio data to extract audio BFCC features and pitch estimation processing on the pre-emphasized lower sub-band audio data to extract audio pitch features including pitch period and pitch correlation; calculating audio Linear Prediction Coding (LPC) coefficients from the higher sub-band audio data; converting the LPC coefficients to line spectral frequencies (LPFs) coefficients; and determining a ratio of energy summation between the lower sub-band data and the higher sub-band audio data, wherein the ration of energy summation, the LPF coefficients, the audio pitch features, and the audio BFCC features form a part of the set of audio features. Extracting a set of audio features for each frame within the set of frames of standardized audio data in the wideband mode includes applying a pre-emphasis process on the standardized audio data of each frame with a high pass filter, thereby forming pre-emphasized standardized audio data; and performing Bark-Frequency Cepstrum Coefficients (BFCC) processing on the pre-emphasized standardized audio data to extract audio BFCC features and pitch estimation processing on the pre-emphasized standardized audio data to extract audio pitch features including pitch period and pitch correlation, wherein the audio pitch features and the audio BFCC features form a part of the set of audio features. Retrieving the set of audio features for each frame within the set of frames of standardized audio data from the audio data packet on the receiving device includes performing an inverse quantization process on the compressed set of audio features to obtain the set of audio features; determining the LPC coefficients for the higher sub-band from the LPF coefficients; and determining the LPC coefficients for the lower sub-band from the BFCC coefficients. In one implementation, the inverse quantization process is an inverse difference vector quantization (DVQ) method, an inverse residual vector quantization (RVQ) method, or an inverse interpolation method. Quantizing the set of audio features includes compressing the set of audio features of each i-frame within the set of frames using a residual vector quantization (RVQ) method or a difference vector quantization (DVQ) method, wherein there is at least one i-frame with the set of frames; and compressing the set of audio features of each non-i-frames within the set of frames using interpolation. In one implementation, the two frequency ranges are 0 to 16 kHz and 16 kHz to 32 kHz respectively; and the noise is suppressed based on machine learning.

Further in accordance with the present teachings is a a computer-implemented method for providing high quality audio for playback over a low bit rate network connection in real-time communication. The method is performed by a real-time communication software application and includes receiving a stream of audio input data on a sending device; suppressing noise from the stream of audio input data to generate clean audio input data on the sending device; splitting the clean audio input data into a set of frames of audio data on the sending device; standardizing each frame within the set of frames to generate a set of frames of standardized audio data on the sending device, wherein audio data of the frame is resampled according to two frequency ranges corresponding to a wideband mode and a super wideband mode, thereby forming lower sub-band audio data and higher sub-band audio data; extracting a set of audio features for each frame within the set of frames of standardized audio data, thereby forming a set of sets of audio features on the sending device; quantizing the set of audio features for each frame within the set of frames of standardized audio data into a compressed set of audio features on the sending device; packaging a set of the compressed sets of audio features into an audio data packet on the sending device; sending the audio data packet to a receiving device on the sending device; receiving the audio data packet in the wideband mode on a receiving device; retrieving the set of audio features for each frame within the set of frames by performing an inverse quantization procedure on the receiving device, wherein the set of audio features includes a set of Bark-Frequency Cepstrum Coefficients (BFCC) coefficients on the receiving device; determining a set of Linear Prediction Coding (LPC) coefficients from the set of BFCC coefficients on the receiving device; determining a linear prediction value of the following sample for each sample of audio data of each frame within the set of frames based on the set of audio features on the receiving device; extracting a context vector for residual signal prediction from acoustic feature vectors for the sample on the receiving device usinge deep learning method; determining a residual signal prediction for the sample based on the context vector and deep learning network, the linear prediction value, a last output signal value and a last predicted residual signal; combining the linear prediction value and the residual signal prediction to generate an audio signal for the sample; and de-emphasizing the generate an audio signal for the sample to form a de-emphasized audio signal for playback on the receiving device. Extracting a set of audio features for each frame within the set of frames of standardized audio data in the super wideband mode includes applying a pre-emphasis process on the lower sub-band audio data with a high pass filter, thereby forming pre-emphasized lower sub-band audio data; performing Bark-Frequency Cepstrum Coefficients (BFCC) processing on the pre-emphasized lower sub-band audio data to extract audio BFCC features and pitch estimation processing on the pre-emphasized lower sub-band audio data to extract audio pitch features including pitch period and pitch correlation; calculating audio Linear Prediction Coding (LPC) coefficients from the higher sub-band audio data; converting the LPC coefficients to line spectral frequencies (LPFs) coefficients; and determining a ratio of energy summation between the lower sub-band data and the higher sub-band audio data, wherein the ration of energy summation, the LPF coefficients, the audio pitch features, and the audio BFCC features form a part of the set of audio features. Extracting a set of audio features for each frame within the set of frames of standardized audio data in the wideband mode includes applying a pre-emphasis process on the standardized audio data of each frame with a high pass filter, thereby forming pre-emphasized standardized audio data; and performing Bark-Frequency Cepstrum Coefficients (BFCC) processing on the pre-emphasized standardized audio data to extract audio BFCC features and pitch estimation processing on the pre-emphasized standardized audio data to extract audio pitch features including pitch period and pitch correlation, wherein the audio pitch features and the audio BFCC features form a part of the set of audio features. In one implementation, the inverse quantization process is an inverse difference vector quantization (DVQ) method, an inverse residual vector quantization (RVQ) method, or an inverse interpolation method. Quantizing the set of audio features includes compressing the set of audio features of each i-frame within the set of frames using a residual vector quantization (RVQ) method or a difference vector quantization (DVQ) method, wherein there is at least one i-frame with the set of frames; and compressing the set of audio features of each non-i-frames within the set of frames using interpolation. In one implementation, the two frequency ranges are 0 to 16 kHz and 16 kHz to 32 kHz respectively; and the noise is suppressed based on machine learning.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a block diagram of a real-time communication system in accordance with this disclosure.

FIG. 2 is a block diagram of a real-time communication device having an improved real-time communication application in accordance with this disclosure.

FIG. 3 is a flowchart depicting a process by which an improved real-time communication application provides high audio quality to remote listeners when the network connection's bit rate is low in accordance with this disclosure.

FIG. 4A is a flowchart illustrating a process by which an improved encoder of an improved real-time communication application extracts super wideband audio features in accordance with this disclosure.

FIG. 4B is a flowchart illustrating a process by which an improved encoder of an improved real-time communication application extracts wideband audio features in accordance with this disclosure.

FIG. 5 is a flowchart illustrating a process by which an improved encoder of an improved real-time communication application compresses audio features in accordance with this disclosure.

FIG. 6 is a flowchart illustrating a process by which an improved decoder of an improved real-time communication application decodes a received super wideband packet and obtains audio data for playback in accordance with this disclosure.

FIG. 7 is a flowchart illustrating a process by which an improved decoder of an improved real-time communication application decodes a received wideband packet and obtains audio data for playback in accordance with this disclosure.

FIG. 8 is a flowchart illustrating a process by which an improved decoder of an improved real-time communication application de-quantizes and decodes a super wideband compressed set of audio features of a frame in accordance with this

A person of ordinary skills in the art will appreciate that elements of the figures above are illustrated for simplicity and clarity, and are not necessarily drawn to scale. The dimensions of some elements in the figures may have been exaggerated relative to other elements to help understanding of the present teachings. Furthermore, a particular order in which certain elements, parts, components, modules, steps, actions, events and/or processes are described or illustrated may not be actually required. A person of ordinary skill in the art will appreciate that, for the purpose of simplicity and clarity of illustration, some commonly known and well-understood elements that are useful and/or necessary in a commercially feasible embodiment may not be depicted in order to provide a clear view of various embodiments in accordance with the present teachings.

### DETAILED DESCRIPTION

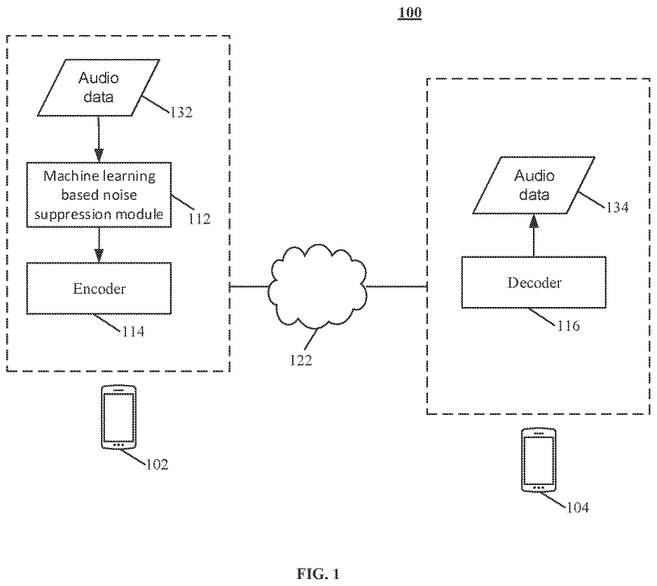

Turning to the Figures and to FIG. 1 in particular, a block diagram illustrating a real-time communication (RTC) system is shown and generally indicated at 100. The RTC system includes a set of electronic communication devices, such as those indicated at 102 and 104, adapted to communicate with each other over a network (such as the Internet) 122. In one implementation, the network communication protocol is Transmission Control Protocol (TCP) and the Internet Protocol (IP) (collectively referred to as TCP/IP). The devices 102-104 are also referred to herein as participating devices. The devices 102-104 connect to the Internet 122 via wireless or wired networks, such as Wi-Fi networks and Ethernet networks.

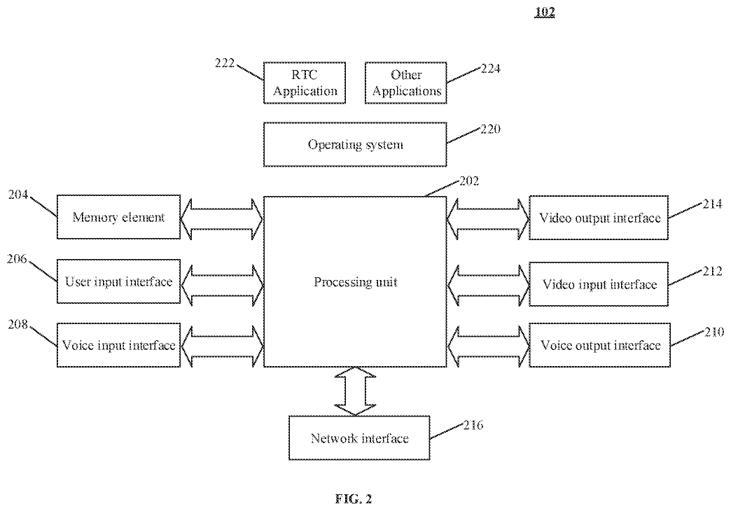

The communication devices 102-104 each can be a laptop computer, a tablet computer, a smartphone, or other types of portable devices capable of accessing the Internet 122 over a network link. Taking the device 102 as an example, the devices 102-104 are further illustrated by reference to FIG. 2.

Referring to FIG. 2, a block diagram illustrating the wireless communication device 102 is shown. The device 102 includes a processing unit 202, some amount of memory 204 operatively coupled to the processing unit 202, one or more user input interfaces (such as a touch pad, a keyboard, a mouse, etc.) 206 operatively coupled to the processing unit 202, a voice input interface (such as a microphone) 208 operatively coupled to the processing unit 202, a voice output interface (such as a speaker) 210 operatively coupled to the processing unit 202, a video input interface (such as a camera) 212 operatively coupled to the processing unit 202, a video output interface (such as a display screen) 214 operatively coupled to the processing unit 202, and a network interface (such as a Wi Fi network interface) 216 operatively coupled to the processing unit 202 for connecting to the Internet 122. The device 102 also includes an operating system (such as iOS®, Android, etc.) 220 running on the processing unit 202. One or more computer software applications 222-224 are loaded and executed on the device 102. The computer software applications 222-224 are implemented using one or more computer software programming languages, such as C, C++, C#, Java, etc.

In one implementation, the computer software application 222 is a real-time communication software application. For example, the application 222 enables an online meeting between two or more of people over the Internet 122. Such a real-time communication involves audio and/or video communication.

Turning back to FIG. 1, the RTC devices 102-104 are adapted to participate in RTC sessions. Each of the 102-104 RTC devices runs the improved RTC application software 222, which includes a machine learning based noise suppression module 112, an encoder 114 and a decoder 116. The audio data 132 is captured by the voice input interface 208 of the device 102 and sent to other participating devices of a RTC session, such as the device 104. Regarding the particular audio data 132, the device 102 is a sending device, i.e., a sender, while the device 104 is a receiving device or a receiver. As to audio data captured by the device 104 and sent to the device 102, the device 104 is the sender while the device 102 is the receiver. The encoder 114 and the decoder 116 are also collectively referred to herein as the codec.

The audio data 132 is first processed by the machine learning based noise reduction module 112 before the processed audio data is encoded by the new encoder 114. The encoded audio data is then sent to the device 104. The received audio data is processed by the new decoder 116 before the decoded audio data 134 is played back on by the voice output interface 210 of the device 104.

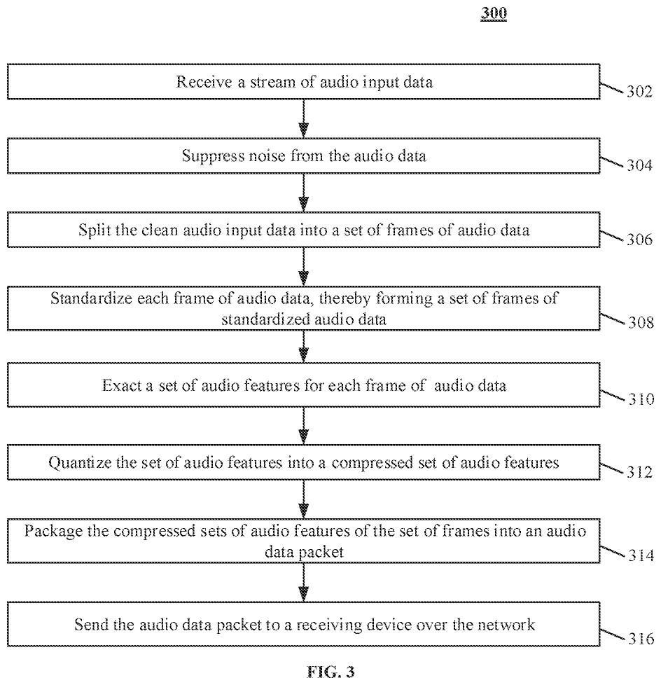

When the network connection between the devices 102-104 becomes slow and has a low bandwidth (meaning low bit rate) due to various conditions, such as congestion and packet loss, the encoder 114 operates as a low bit rate audio codec while the decoder 116 operates as a high quality decoder to reduce demand and requirement for network bandwidth while maintain the quality of the audio data 134 for the listener. The process by which the improved RTC application 222 for providing high quality audio communication over weak network situations is further illustrated by reference to FIG. 3.

Referring to FIG. 3, a flowchart depicting a process by which the improved RTC application 222 provides high audio quality using a new low bit rate audio encoder 114 and a new high quality decoder 116 when the network connection's bit rate is low is shown and generally indicated at 300. At 302, the RTC application 222 receives a stream of audio data 132. At 304, the machine learning based noise suppression module 112 of the RTC application 222 processes the audio data 132 to suppress and reduce noise from it.

The performance of the conventional neural-network-based generative vocoder drops when the noise in audio data is present. In particular, transition noise significantly degrades synthesized speech intelligibility. Accordingly, noise in audio data is desired to be reduced or even eliminated before the encoding stage. The conventional noise suppression (NS) algorithms, based on statistic methods, are only effective when stable background noise is present. The improved RTC application 222 deploys the machine learning based noise suppression (ML-NS) module 112 to reduce noise in the audio data 132. The ML-NS module uses, for example, Recurrent Neural Network (RNN) and/or Convolutional Neural Network (CNN) algorithms to reduce noise in the audio data 132.

The output of the element 304 is also referred to herein as clean audio data. In situations where the element 304 is not performed, the audio data 132 is also referred to here as the clean audio data. At 306, the improved encoder 114 splits the clean audio data into a set of frames of audio data. Each frame is, for example, five or ten milliseconds (ms) long.

At 308, the improved encoder 114 standardizes each frame within the set of frames. The audio data in each frame is Pulse-code Modulation (PCM) data. The improved encoder 114 and decoder 116 operate in two modes: wideband and super wideband. In one implementation, at 308, the clean audio data is resampled to 16 kHz and 32 kHz for wideband mode and super wideband mode respectively. Their bitrates are 2.1 kbps and 3.5 kbps respectively. Accordingly, at 308, the improved encoder 114 decomposes the standardized PCM data of each frame into two sub-bands of audio data. In one implementation, the low sub-band (also referred to herein as lower sub-band) of audio data contains audio data of sampling rate from 0 kHz to 16 kHz while a high sub-band (also referred to herein as higher sub-band) of audio data contains audio data of sampling rate from 16 kHz to 32 kHz. Accordingly, each frame includes the decomposed lower sub-band audio data and the decomposed higher sub-band audio data when there are two sub-bands. After the element 308 is performed, each frame is also referred to herein as decomposed frame or decomposed frame of audio data. In one implementation, the decomposition is performed using a quadrature mirror filter (QMF). The QMF filter also avoids frequency spectrum alias.

As 310, the improved encoder 114 extracts a set of audio features for each frame of the audio data. In super wideband mode, the set of features includes, for example, 18 bins of Bark-Frequency Cepstrum Coefficients (BFCC), pitch period, pitch correlation for the low sub-band, line spectral frequencies (LSF) for the higher sub-band, and ratio of energy summation between lower sub-band audio data and higher sub-band audio data for each frame. In wideband mode, the set of features include 18 bins of BFCC, pitch period, and pitch correlation. The feature vectors preserve the original waveform information with much smaller data sizes. Vector quantization methods can be performed to further reduce the data size of feature vectors. The present teachings compress the original PCM data over 95% with a limited loss of audio quality.

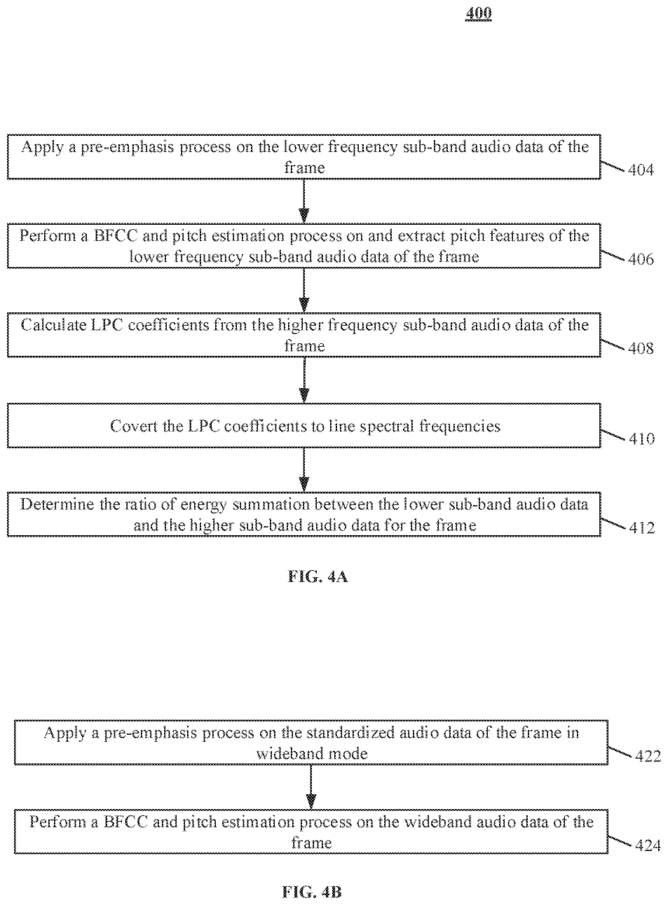

The audio feature extraction for super wideband mode at 310 is further illustrated by reference to FIG. 4A. Turning to FIG. 4A, a flowchart illustrates a process by which the encoder 114 extracts audio features for each frame of audio data in the super wideband mode is shown and generally indicated at 400. At 404, the improved encoder 114 pre-emphasizes the PCM data with a high pass filter, such as the Infinite Impulse Response (IIR) filter, thereby forming pre-emphasized lower sub-band audio data. At 406, the improved encoder 114 then performs BFCC calculation on the pre-emphasized lower sub-band audio data. In addition, at 406, the improved encoder 114 extracts pitch features including pitch period, and pitch correlation from the lower frequency sub-band audio data. Since LPC coefficients α can be estimated from BFCC, only BFCC, pitch period, and pitch correlation are explicitly expressed in the feature vector. LPC stands for Linear Prediction Coding.

At the elements 408, 410 and 412, for each frame of audio data, the improved encoder 114 operates on the higher frequency sub-band audio data. At 408, the encoder 114 calculates LPC coefficients (such as a_h) using, for example, the Burgs algorithm. At 410, the encoder 114 converts the LPC coefficients to line spectral frequencies (LSF). At 412, the improved encoder 114 determines the ratio of energy summation between lower sub-band audio data and higher sub-band audio data for each frame. In one implementation, the summation includes the energy ratio between two sub-bands. The audio feature vector for each frame thus includes BFCC, pitch, LSF, and energy ratio between two sub-bands. The elements 402-406 are also collectively referred to herein as extracting a set of audio features of a frame within a lower sub-band of audio data, while the elements 408-412 are also collectively referred to herein as extracting a set of audio features of a frame within a higher sub-band of audio data. The audio features include the ratio of energy summation and the line spectral frequencies (LSF), which are referred to herein as audio energy features and audio LPC features respectively.

The audio feature extraction at 310 in the wideband mode is further illustrated by reference to FIG. 4B. At 422, the improved encoder 114 pre-emphasizes the PCM data with a high pass filter, such as the Infinite Impulse Response (IIR) filter, thereby forming pre-emphasized audio data. At 424, the improved encoder 114 performs BFCC, and pitch estimation including pitch period and pitch correlation calculation on the pre-emphasized audio data.

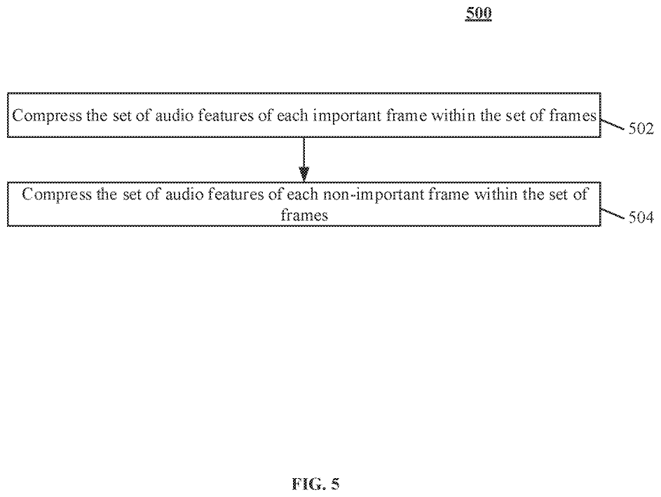

Turning back to FIG. 3, at 312, the improved encoder 114 compresses the extracted set of audio features for each frame using a signal compressor, such as a vector quantization and frame correlation method. In one implementation, the signal compressor is a difference vector quantization (DVQ) method. Alternatively, the signal compressor is a residual vector quantization (RVQ) method. In a further implementation, the compression uses a proper interpolation policy. The compression process is further illustrated by reference to FIG. 5.

Referring to FIG. 5, a flowchart illustrating a process by which the improved encoder 114 compresses the sets of audio features of the set of frames is shown and generally indicated at 500. At 502, the improved encoder 114 compresses the set of audio features of each important frame within the set of frames using, for example, a residual vector quantization (RVQ) method. In one implementation, in each packet, at least one frame is coded with the RVQ method. Such a frame is referred to herein as important frame (i-frame). Other frames (also referred to herein as non-i-frame, non-important frames and rest-frames). At 504, the improved encoder 114 compresses the set of audio features of each non-i-frame within the set of frames using, for example, interpolation.

Acoustic features for adjacent audio frames have a strong local correlation. For example, a phoneme pronunciation typically spans over several frames. Therefore, a rest-frame's feature vector can be retrieved from its neighboring frame's feature vector by interpolation. Interpolation methods, such as difference vector quantization (DVQ) or polynomial interpolation, can be used to achieve the goal. For example, where there are four frames (meaning four sets of audio features of the four frames of audio data in the same packet) in one packet, and only the 2nd and 4th frames are quantized with RVQ. The 1st frame is interpolated from the 2nd frame and the 4th frame from previous packet, and the 3rd frame is interpolated from the 2nd and the 4th frame using DVQ. Encoding interpolation parameters requires even fewer bits of data than the RVQ method. However, interpolation may be less accurate than the RVQ method.

Turning back to FIG. 3, at 314, the improved encoder 114 packages a set of compressed sets of audio features of a set of frames into an audio data packet. In one implementation, each packet includes four sets of compressed audio features corresponding to four frames of audio data. An illustrative packet is shown in the table below:

Example of 40 ms (4 frames) Packet with Bit Allocation

| | Bits | |
|---|---|---|
| | wideband mode | super wideband |
| Parameter | (16 kHz) | mode (32 kHz) |
| Frame 2/4 pitch period | 14 | 14 |
| Frame 1/2/3/4 pitch correlation | 4 | 4 |
| Frame 2/4 BFCC RVQ | 44 | 44 |
| Frame 2/4 Higher-band LPS RVQ | 0 | 44 |
| Frame 1/3 pitch period interpolation | 5 | 5 |
| Frame 1/3 BFCC DVQ | 16 | 16 |
| Frame 1/3 Higher-band LSF DVQ | 0 | 13 |
| Total | 83 | 140 |

In the example, the total number of bits of the data payload is 140 for a 40 ms packet, which is equivalent to the bitrate of 2.1 kbps and 3.5 kbps for wideband and super wideband mode respectively. At 316, the RTC application 222 sends the packet over the Internet 122 to the device 104. For example, the transmission can be implemented using the UDP protocol. The RTC application 222 running on the device 104 receives the packet and processes it.

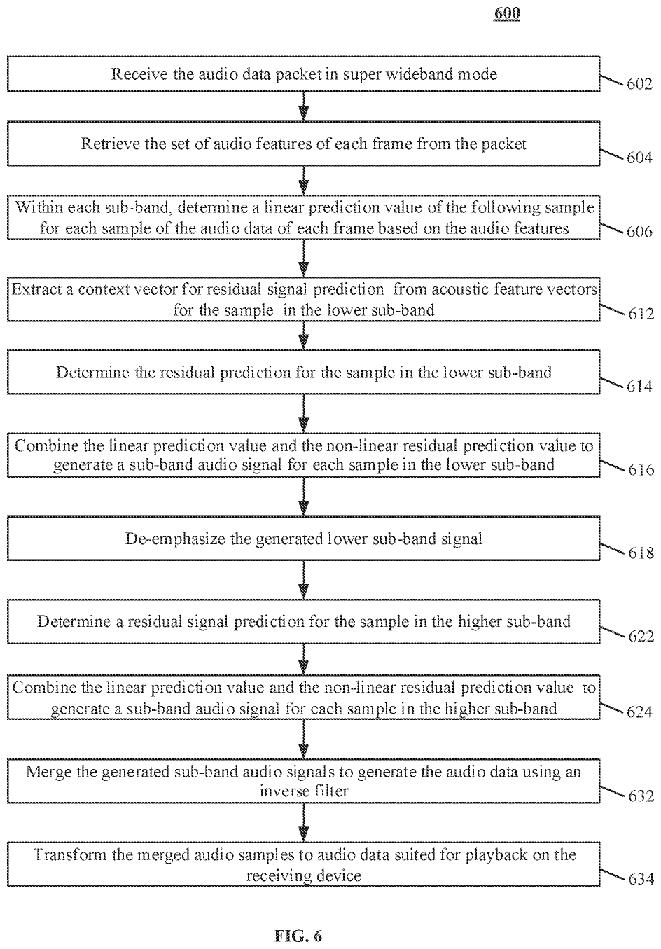

Referring now to FIG. 6, a flowchart illustrating a process by which the improved decoder 116 decodes a received packet in super wideband mode and obtains audio data for playback on the receiving device 116 is shown and generally indicated at 600. At 602, the improved decoder 116 receives the audio data packet sent by the sender device 102 at 316. Once the packet is retrieved, at 604, the improved decoder 116 retrieves the set of audio features of each frame from the packet. When the sub-bands are 0 kHz-16 kHz and 16 kHz-32 kHz, the higher sub-band has the sampling frequency range of 16 kHz-32 kHz while the lower sub-band has the other range. For the higher sub-band, the LPC coefficients and energy features (such as the ratios of energy summation between the lower and higher sub-bands) are directly retrieved from the packet.

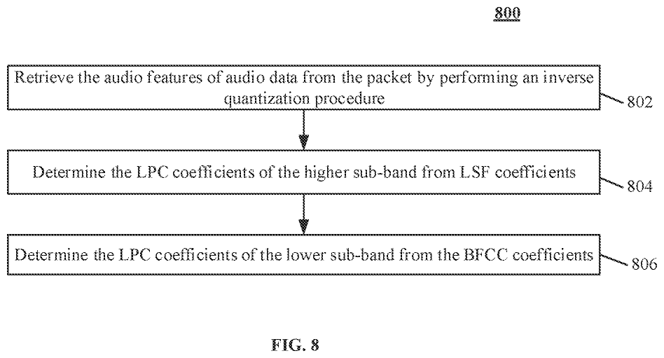

The process to retrieve the set of audio features of each frame is further illustrated by reference to FIG. 8. Referring now to FIGS. 8, a flowchart illustrating a process by which the improved decoder 116 dequantizes a compressed set of audio features of a frame in super wideband mode is shown and generally indicated at 800. At 802, the improved decoder 116 retrieves the audio features, such as BFCC, pitch period and correlation, LSF, and energy ratio, of the frame from the packet by performing an inverse quantization procedure corresponding to the process performed at 312. At 804, the improved decoder 116 determines the LPC coefficients of the higher sub-band of audio data of the frame. At 806, the improved decoder 116 determines the LPC coefficients of the lower sub-band from the BFCC features. As used herein, the audio features retrieved at 802 is also referred to as a first subset of audio features; the audio features retrieved at 804 is also referred to as a second subset of audio features; and the audio features retrieved at 806 is also referred to as a third subset of audio features.

The total speech signal at each sub-band is decomposed into linear and non-linear part. In one implementation, the linear prediction value is determined using a LPC model that generates the value auto-regressively with the LPC coefficients as the input audio features. The total speech signal for each sub-band at time t can be expressed as:

$${s}_{t} = {\sum }_{i = 1}^{k} {α}_{i} * {s}_{t - i} + {e}_{t}$$

where k is the order of the LPC model, αᵢ is the i-th LPC coefficient, sₜ₋ᵢ are past i-th sample and eₜ is the residual signal. LPC coefficients are optimized by minimizing the excitation eₜ. The first term, shown below, represents the LPC prediction value

$${p}_{t} = {\sum }_{i = 1}^{k} {α}_{i} * {s}_{t - i}$$

The equation above is used to estimate the LPC prediction value in each sub-band at 606. And a neural network model can only focus on predicting non-linear residual signals at 612 and 614 for lower sub-band. In this way, computation complexity can be significantly reduced while achieving high-quality speech generation.

Turning back to FIG. 6, at 606, within each sub-band, determines a linear prediction value of the following sample for each sample of the audio data of each frame based on the audio features. The audio samples are, for example, PCM samples. In one implementation, at 606, a linear prediction value of each audio data sample is determined. At 612, the improved decoder 116 extracts a context vector for residual signal estimation at 614 from acoustic feature vectors.

The element 612 is performed for each frame with audio features BFCC, pitch period, and correlation as input. Since pitch period is an important feature for residual prediction, its value is first bucketed and then mapped to a larger feature space to enrich its representation. Then, the pitch feature is concatenated with other acoustic features and fed into 1D convolutional layers. The convolution layers bring a wider respective field in the time dimension. After that, the output of CNN layers goes through residue connection with full-connected layers, resulting in the final context vector c_{f} (also referred herein as c_{l,f}). The context vector c_{f} is one input of residue prediction network and keeps constant during data generation for the f-th frame.

At 614, the improved decoder 116 determines the prediction error (also referred to herein as a residual signal prediction). In other words, at 614, the improved decoder 116 conducts a residual signal estimation. The residual signals eₜ are modeled and predicted by a neural network (also referred hereto as a residual prediction network) algorithm. The input feature consists of condition network output vector c_{f}, current LPC prediction signal pₜ and the last prediction of non-linear residual signal eₜ and full signal sₜ. To enrich the signal embedding, signals are firstly converted to the mu-law domain and then mapped to a high dimensional vector using a shared embedding matrix. The concatenated feature is fed into RNN layers and followed by a fully connected layer. Thereafter, softmax activation is used to calculate the probability distribution of eₜ in non-symmetric quantization pulse-code modulation (PCM) domain, such as μ-law or A-law. Instead of choosing the value with maximum probability, the final values of eₜ are selected using a sampling policy.

At 616, the improved decoder 116 combines the linear prediction value and the non-linear prediction error to generate a sub-band audio signal for each sample. The generated sub-band audio signal (sₜ) is the sum of pₜ and eₜ. Since lower sub-band signal is emphasized during encoding, so the output signal sₜ needs to be de-emphasized to obtain the original signal. Accordingly, at 618, the improved decoder 116 de-emphasizes the generated lower sub-band signal to form a de-emphasized lower sub-band audio signal. For example, if the PCM samples are emphasized with a high pass filter when encoded, a low pass filter is applied to de-emphasize the output signal. It is also referred to herein as de-emphasis.

At 622, for higher frequency sub-band signal, the residual signal is estimated using the following equation:

$${e}_{h , t} = \frac{{E}_{h}}{{E}_{l}} {e}_{l , t}$$

where e_{h,t} and e_{l,t} are residual signals at time t for the higher band and lower band. Eₕ and Eₗ are the energy of the current frame for the higher-band and lower-band.

At 624, the improved decoder 116 combines the linear prediction value and the residual prediction to generate a sub-band audio signal for each sample in the higher sub-band. At 632, the improved decoder 116 merges the a de-emphasized lower sub-band audio signal and the generated sub-band audio signal for the higher sub-band, generated at 618 and 624 respectively, to generate the audio data using an inverse Quadrature Mirror Filter (QMF). The elements 622-624 are performed for audio features of a frame of the higher sub-band audio data. For example, if the PCM samples are emphasized with a high pass filter when encoded, a low pass filter is applied to de-emphasize the output signal. It is also referred to herein as de-emphasis. The generated audio data is also referred to herein as de-emphasized audio data or samples, such as waveform signals at 32 kHz. When merged audio samples does not match the proper playback format. For example, when the merged audio samples' format is 8-bit μ-law, they need to be transformed to 16 bit linear PCM format for playback on the device 104. In such a case, at 634, the improved decoder 116 transforms the merged audio samples to the audio data 134 for playback by the device 104.

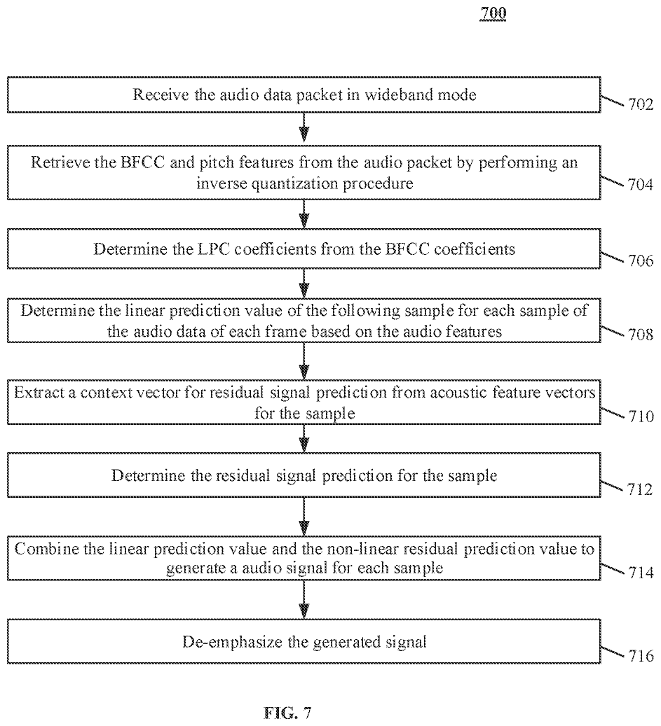

Referring now to FIG. 7, a flowchart illustrating a process by which the improved decoder 116 decodes a received packet in wideband mode is shown and generally indicated at 700. At 702, the improved decoder 116 receives the audio data packet sent by the sender device 102 at 316. At 704, the improved decoder 116 retrieves the audio features, such as the BFCC, pitch period and pitch correlation vectors of the wideband audio data, by performing an inverse vector quantization procedure corresponding to the process performed at 312. At 706, the improved decoder 116 determines the LPC coefficients from the BFCC features. Then the improved decoder 116 reconstructs the signal in an autoregressive manner. At 708, the improved decoder 116 calculates the prediction value of the current sample using LPC coefficients and past 16 output signals. In one implementation, the prediction value is a linear prediction value. At 710, a context vector is extracted using BFCC and pitch features. At 712, the non-linear residual signal prediction is predicted conditioned on context vector, current linear prediction value, last output signal value and last predicted residual signal. At 714, the current signal is determined by summing the linear and non-linear residual prediction values. At 716, de-emphasize operation is performed on output signal since the corresponding original signal was emphasized at 404.

Obviously, many additional modifications and variations of the present disclosure are possible in light of the above teachings. Thus, it is to be understood that, within the scope of the appended claims, the disclosure may be practiced otherwise than is specifically described above. For example, there are a few alternative designs of residual prediction networks. First, RNN has many variants, such as GRU, LSTM, SRU units, etc. Second, instead of predicting residual signal eₜ, predicting sₜ directly is an alternative. Third, batch sampling makes it possible to predict multiple samples in a single time step. This method typically improves decoding efficiency at the cost of degrading audio quality. The residual signal e_{l,t} is predicted using the network described above, where subscript l denotes low sub-band (h denotes high sub-band) and t is the time step. Then the full signal s_{l,t}′ is the sum of LPC prediction p_{l,t} and residual signal e_{l,t}. This value is then fed into the LPC module to predict p_{l,t+1}.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It should be recognized that the words “a” or “an” are intended to include both the singular and the plural. Conversely, any reference to plural elements shall, where appropriate, include the singular.

It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A computer-implemented method for providing high quality audio for playback over a low bit rate network connection in real-time communication, said method performed by a real-time communication software application and comprising:
1) receiving a stream of audio input data on a sending device;
2) suppressing noise from said stream of audio input data to generate clean audio input data on said sending device;
3) splitting said clean audio input data into a set of frames of audio data on said sending device;
4) standardizing each frame within said set of frames to generate a set of frames of standardized audio data on said sending device, wherein audio data of said frame is resampled according to two frequency ranges corresponding to a wideband mode and a super wideband mode, thereby forming lower sub-band audio data and higher sub-band audio data;
5) extracting a set of audio features for each frame within said set of frames of standardized audio data, thereby forming a set of sets of audio features on said sending device;
6) quantizing said set of audio features for each frame within said set of frames of standardized audio data into a compressed set of audio features on said sending device;
7) packaging a set of said compressed sets of audio features into an audio data packet on said sending device;
8) sending said audio data packet to a receiving device on said sending device;
9) receiving said audio data packet in said super wideband mode on a receiving device;
10) retrieving said set of audio features for each frame within said set of frames of standardized audio data from said audio data packet on said receiving device;
11) within both a lower sub-band and a higher sub-band of said super wideband mode, determining a linear prediction value of the following sample for each sample of said audio data of each frame based on said set of audio features corresponding to said frame on said receiving device;
12) extracting a context vector for residual signal prediction from acoustic feature vectors for said sample in said lower sub-band on said receiving device;
13) determining a first residual prediction for said sample in said lower sub-band on said receiving device using deep learning method;
14) combining said linear prediction value and said first residual prediction to generate a sub-band audio signal for said sample in said lower sub-band on said receiving device;
15) de-emphasizing said sub-band audio signal to form a de-emphasized lower sub-band audio signal on said receiving device;
16) determining a second residual prediction for said sample in said higher sub-band on said receiving device;
17) combining said linear prediction value and said second residual prediction to generate a sub-band audio signal for said sample in said higher sub-band on said receiving device;
18) merging said de-emphasized lower sub-band audio signal and said sub-band audio signal for said sample in said higher sub-band, thereby forming a merged audio sample on said receiving device; and
19) transforming said merged audio sample to audio data for playback on said receiving device.

2. The method of claim 1, wherein extracting a set of audio features for each frame within said set of frames of standardized audio data in said super wideband mode includes:
1) applying a pre-emphasis process on said lower sub-band audio data with a high pass filter, thereby forming pre-emphasized lower sub-band audio data;
2) performing Bark-Frequency Cepstrum Coefficients (BFCC) processing on said pre-emphasized lower sub-band audio data to extract audio BFCC features and pitch estimation processing on said pre-emphasized lower sub-band audio data to extract audio pitch features including pitch period and pitch correlation;
3) calculating audio Linear Prediction Coding (LPC) coefficients from said higher sub-band audio data;
4) converting said LPC coefficients to line spectral frequencies (LPFs) coefficients; and
5) determining a ratio of energy summation between said lower sub-band data and said higher sub-band audio data, wherein said ration of energy summation, said LPF coefficients, said audio pitch features, and said audio BFCC features form a part of said set of audio features.

3. The method of claim 1, wherein extracting a set of audio features for each frame within said set of frames of standardized audio data in said wideband mode includes:
1) applying a pre-emphasis process on said standardized audio data of each frame with a high pass filter, thereby forming pre-emphasized standardized audio data; and
2) performing Bark-Frequency Cepstrum Coefficients (BFCC) processing on said pre-emphasized standardized audio data to extract audio BFCC features and pitch estimation processing on said pre-emphasized standardized audio data to extract audio pitch features including pitch period and pitch correlation, wherein said audio pitch features and said audio BFCC features form a part of said set of audio features.

4. The method of claim 1, wherein retrieving said set of audio features for each frame within said set of frames of standardized audio data from said audio data packet on said receiving device includes:
1) performing an inverse quantization process on said compressed set of audio features to obtain said set of audio features;
2) determining said LPC coefficients for said higher sub-band from said LPF coefficients; and
3) determining said LPC coefficients for said lower sub-band from said BFCC coefficients.

5. The method of claim 4, wherein said inverse quantization process is an inverse difference vector quantization (DVQ) method, an inverse residual vector quantization (RVQ) method, or an inverse interpolation method.

6. The method of claim 1, wherein quantizing said set of audio features includes:
1) compressing said set of audio features of each i-frame within said set of frames using a residual vector quantization (RVQ) method or a difference vector quantization (DVQ) method, wherein there is at least one i-frame with said set of frames; and
2) compressing said set of audio features of each non-i-frames within said set of frames using interpolation.

7. The method of claim 1, wherein said two frequency ranges are 0 to 16 kHz and 16 kHz to 32 kHz respectively.

8. The method of claim 1, wherein said noise is suppressed based on machine learning.

9. A computer-implemented method for providing high quality audio for playback over a low bit rate network connection in real-time communication, said method performed by a real-time communication software application and comprising:
1) receiving a stream of audio input data on a sending device;
2) suppressing noise from said stream of audio input data to generate clean audio input data on said sending device;
3) splitting said clean audio input data into a set of frames of audio data on said sending device;
4) standardizing each frame within said set of frames to generate a set of frames of standardized audio data on said sending device, wherein audio data of said frame is resampled according to two frequency ranges corresponding to a wideband mode and a super wideband mode, thereby forming lower sub-band audio data and higher sub-band audio data;
5) extracting a set of audio features for each frame within said set of frames of standardized audio data, thereby forming a set of sets of audio features on said sending device;
6) quantizing said set of audio features for each frame within said set of frames of standardized audio data into a compressed set of audio features on said sending device;
7) packaging a set of said compressed sets of audio features into an audio data packet on said sending device;
8) sending said audio data packet to a receiving device on said sending device;
9) receiving said audio data packet in said wideband mode on a receiving device;
10) retrieving said set of audio features for each frame within said set of frames by performing an inverse quantization procedure on said receiving device, wherein said set of audio features includes a set of Bark-Frequency Cepstrum Coefficients (BFCC) coefficients on said receiving device;
11) determining a set of Linear Prediction Coding (LPC) coefficients from said set of BFCC coefficients on said receiving device;
12) determining a linear prediction value of the following sample for each sample of audio data of each frame within said set of frames based on said set of audio features on said receiving device;
13) extracting a context vector for residual signal prediction from acoustic feature vectors for said sample on said receiving device using deep learning method;
14) determining a residual signal prediction for said sample based on said context vector and deep learning network, said linear prediction value, a last output signal value and a last predicted residual signal;
15) combining said linear prediction value and said residual signal prediction to generate an audio signal for said sample; and
16) de-emphasizing said generate an audio signal for said sample to form a de-emphasized audio signal for playback on said receiving device.

10. The method of claim 9, wherein extracting a set of audio features for each frame within said set of frames of standardized audio data in said super wideband mode includes:
1) applying a pre-emphasis process on said lower sub-band audio data with a high pass filter, thereby forming pre-emphasized lower sub-band audio data;
2) performing Bark-Frequency Cepstrum Coefficients (BFCC) processing on said pre-emphasized lower sub-band audio data to extract audio BFCC features and pitch estimation processing on said pre-emphasized lower sub-band audio data to extract audio pitch features including pitch period and pitch correlation;
3) calculating audio Linear Prediction Coding (LPC) coefficients from said higher sub-band audio data;
4) converting said LPC coefficients to line spectral frequencies (LPFs) coefficients; and
5) determining a ratio of energy summation between said lower sub-band data and said higher sub-band audio data, wherein said ration of energy summation, said LPF coefficients, said audio pitch features, and said audio BFCC features form a part of said set of audio features.

11. The method of claim 9, wherein extracting a set of audio features for each frame within said set of frames of standardized audio data in said wideband mode includes:
1) applying a pre-emphasis process on said standardized audio data of each frame with a high pass filter, thereby forming pre-emphasized standardized audio data; and
2) performing Bark-Frequency Cepstrum Coefficients (BFCC) processing on said pre-emphasized standardized audio data to extract audio BFCC features and pitch estimation processing on said pre-emphasized standardized audio data to extract audio pitch features including pitch period and pitch correlation, wherein said audio pitch features and said audio BFCC features form a part of said set of audio features.

12. The method of claim 9, wherein said inverse quantization process is an inverse difference vector quantization (DVQ) method, an inverse residual vector quantization (RVQ) method, or an inverse interpolation method.

13. The method of claim 9, wherein quantizing said set of audio features includes:
1) compressing said set of audio features of each i-frame within said set of frames using a residual vector quantization (RVQ) method or a difference vector quantization (DVQ) method, wherein there is at least one i-frame with said set of frames; and
2) compressing said set of audio features of each non-i-frames within said set of frames using interpolation.

14. The method of claim 9, wherein said two frequency ranges are 0 to 16 kHz and 16 kHz to 32 kHz respectively.

15. The method of claim 9, wherein said noise is suppressed based on machine learning.
